(19) United States
(12) Patent Application Publication
(10) Pub. No.: US 2012/0208397 A1
(43) Pub. Date: Aug. 16, 2012

(54) ELECTRICAL JUNCTION BOX FOR A PHOTOVOLTAIC MODULE

(75) Inventors: Sascha Schwarze, Berlin (DE); Marcel Totzek, Berlin (DE)

(73) Assignee: SOLON SE, Berlin (DE)

(21) Appl. No.: 13/349,769

(22) Filed: Jan. 13, 2012

(30) Foreign Application Priority Data
Jan. 14, 2011 (DE) 10 2011 009 005

(51) Int. Cl. H01R 13/60

(52) U.S. Cl. 439/534

(57) ABSTRACT

An electrical junction box for a photovoltaic module includes a box receptacle including a plurality of positive contacts configured to contact a positive pole of the photovoltaic module and a plurality of negative contacts configured to contact a negative pole of the photovoltaic module. A box lid includes a positive connection cable connected to at least one positive mating contact and a negative connection cable connected to at least one negative mating contact. The box lid is configured to be disposed on the box receptacle in a plurality of selectable fitting positions each based on a respective predetermined alignment of the connection cables. In each fitting position, the at least one positive mating contact and the at least one negative mating contact of the box lid are configured to respectively electrically contact the associated respective positive contact and the associated respective negative contact of the box receptacle.

### CROSS-REFERENCE TO PRIOR APPLICATION

Priority is claimed to German Patent Application No. DE 10 2011 009 005, filed on Jan. 14, 2011, the entire disclosure of which is hereby incorporated by reference herein.

### FIELD

The invention relates to an electrical junction box for a photovoltaic module.

### BACKGROUND

DE 10 2008 028 462 A1 describes a two-part electrical junction box for a photovoltaic module with a box receptacle and a box lid. The box receptacle of the junction box incorporates two positive and two negative contacts, which are correspondingly connected in an electrically conductive manner with two positive and two negative conductor strips of the photovoltaic module. The conductor strips correspondingly comprise the positive pole and negative pole of the photovoltaic module. Situated in the box lid of the junction box are two positive and two negative mating contacts, which electrically contact the correspondingly equal-polarity contacts in the box receptacle with the box lid placed on the box receptacle. Equal-polarity contacts in the box receptacle and mating contacts in the box lid are each interconnected in an electrically conductive manner by means of bus bars. The two positive mating contacts are rigidly connected with a positive connection cable, while the two negative mating contacts are rigidly connected with a negative connection cable for the photovoltaic module. The box lid exhibits a continuous wall, from the side of which the connection cables are brought out. The connection cables are secured to the box lid under a fixed outgoing direction. The box receptacle and box lid have a symmetrical rectangular shape. All contacts are arranged along a longitudinal side in the box receptacle. The mating contacts are arranged in the box lid along the longitudinal side corresponding to the longitudinal side in the box receptacle in the fitted state. In order to establish contact between the contacts and mating contacts, the box lid can thus only be placed on the box receptacle in a single fitting position. All four contacts and all four mating contacts can only be contacted with each other in a single fitting position of the box lid on the box receptacle. A corresponding alignment of the two connection cables arises as a result of their fixed outgoing direction from the box lid. Therefore, the connection cables must be aligned relative to the photovoltaic module using other means. However, this can involve a very high outlay, since the existing plurality of different components on the photovoltaic module often yields only a very tight installation space or a preferred alignment for the connection cables. In particular when establishing an electrical connection between individual photovoltaic modules, unfavorable alignments of the connection cables can also come about, requiring very long connection cables.

DE 10 2008 048 443 A1 describes a junction box for a photovoltaic module with a circular design that consists of a modular system comprised of a box receptacle, a box lid and an annular box wall. The connection cables are rigidly connected with the box wall under a prescribed outgoing direction. Due to a special internal structure in the junction box, the box lid can only be placed on the box receptacle in a single fitting position, so that the connection cables in turn depart from the junction box in only a fixed, prescribed alignment. Other alignments for the connection cables can only be achieved by changing out the entire box wall for another box wall having another fixed configuration of connection cables.

DE 10 2008 022 049 A1 describes a junction box for photovoltaic modules in which contact is also established by placing on the box lid. The box lid also incorporates other functional elements, such as bypass diodes, cooling elements or membranes for gas exchange inside the box.

DE 10 2004 048 770 B4 describes a housing arrangement consisting of at least two junction boxes for connecting an electrical device. An electrical connection cable here departs from each junction box with a fixed outgoing direction. In order to be able to select the alignment of connection cables relative to each other and the electrical device, the junction boxes have a square design, and can be mounted on top of each other in four different positions rotated by a respective 90° to each other. However, this already yields a relatively large overall height for two connection cables, so that such a concept with stacked junction boxes cannot be used in a photovoltaic module, since the latter is to be as flat as possible.

### SUMMARY

In an embodiment, the present invention provides an electrical junction box for a photovoltaic module including a box receptacle including a plurality of positive contacts configured to contact a positive pole of the photovoltaic module and a plurality of negative contacts configured to contact a negative pole of the photovoltaic module. A box lid includes a positive connection cable connected to at least one positive mating contact and a negative connection cable connected to at least one negative mating contact. The connection cables are connected to the box lid in a fixed outgoing direction. The box lid is configured to be disposed on the box receptacle in a plurality of selectable fitting positions each based on a respective predetermined alignment of the connection cables. A respective one of the positive contacts and a respective one of the negative contacts of the box receptacle are associated with each fitting position. In each fitting position, the at least one positive mating contact and the at least one negative mating contact of the box lid are configured to respectively electrically contact the associated respective positive contact and the associated respective negative contact of the box receptacle.

### BRIEF DESCRIPTION OF THE DRAWINGS

The present invention will be described in even greater detail below based on the exemplary, diagrammatic figures, which are not to scale. The invention is not limited to the exemplary embodiments. Other features and advantages of various embodiments of the present invention will become apparent by reading the following detailed description with reference to the attached drawings which illustrate the following:

FIG. 1 shows a square junction box, open view.

FIG. 2A-F shows possible fitting positions for the square junction box,

FIG. 3 shows possible fitting positions for the square junction box in relation to the photovoltaic module,

FIG. 4A, B shows two configurations of the photovoltaic module based on the possible fitting positions,

FIG. 5 shows a first embodiment of the junction box focusing on the fixation of the fitting position,

FIG. 6 shows a second embodiment of the junction box focusing on the fixation of the fitting position,

FIG. 7 shows a cross section of the junction box with an embodiment of the contacts in the box receptacle,

FIG. 8 shows an octagonal junction box, open view,

FIG. 9 shows a round junction box, open view, and

FIG. 10 shows an embodiment of the square junction box focusing on the bypass diodes.

### DETAILED DESCRIPTION

In an embodiment, the present invention provides an electrical junction box for a photovoltaic module with a box receptacle having at least one first and one second positive contact for contacting the positive pole of the photovoltaic module and at least one first and one second negative contact for contacting the negative pole of the photovoltaic module and a box lid with at least one positive mating contact and at least one negative mating contact, wherein the mating contacts contact the equal-polarity contacts after the box lid has been placed on the box receptacle in at least one mounting position, and with a positive connection cable linked to the at least one positive mating contact and a negative connecting cable linked to the at least one negative mating contact, which are secured to the box lid under a fixed outgoing direction.

A photovoltaic module, also referred to as PV module, solar module or solar cell module, essentially consists of a matrix of solar cells electrically interconnected via cell and cross connection links, and is used to generate current directly from sunlight as the result of photoelectric effects in photoactive materials. A direct current can be tapped between the positive pole and negative pole of a photovoltaic module. This tapping takes place by way of an electrical junction box, also conduit box, in which the module-internal conductor strips, for example cross connection links, are electrically contacted by the solar cells with external connection cables. The external connection cables are used at the assembly site to electrically wire the photovoltaic module with additional photovoltaic modules to increase the usable output voltage, or with an inverter in front of the consumer. As a rule, the electrical junction box consists of a box lid and a box receptacle, which, on the top or bottom side of the photovoltaic module or on its substrate or laminate in which the solar cells, are bolted, adhesively bonded or laminated into the edge region thereof. The box receptacle encompasses contacts to be connected with the conductor strips or cross connection links, as a rule the connection cables in addition to strain reliefs, protective elements for preventing a reverse operation of the photovoltaic module when individual solar cells become damaged or shaded, and connection elements for assembly on the substrate or laminate of the photovoltaic module. The box lid serves as a protective element for the box receptacle after it has been mounted on the PV module, sealing it against exposure to weather, and to provide electrical operational safety. After the contacts in the box receptacle have been connected with strip conductors in the photovoltaic module, mating contacts linked in an electrically conductive manner with the connection cables are connected in an electrically conductive manner with the contacts. This can be done while the box receptacles are still unsealed or by putting on the box lid when the mating contacts and connection cables are situated in or on the box lid. Depending on the arrangement of mating contacts, the connection cables are correspondingly rigidly connected with the box receptacle or box lid. The box lid is subsequently rigidly connected with the box receptacle, so that the junction box is sealed. Moisture is prevented from penetrating by grouting the box receptacle in advance with a plastic or inserting a gasket between the box receptacle and box lid. In known junction boxes for photovoltaic modules, the alignment of the connection cable departing from the junction box is forcibly fixed relative thereto. For this reason, it has thus far been necessary to install the connection cables accordingly during the continued assembly of the photovoltaic module. In addition, it is not possible to already mount a junction box on a laminate if the laminate has not yet been specifically allocated to a photovoltaic module. Therefore, the junction box can only be set in a relatively later stage of production, which increases production costs.

In an embodiment, the present invention further develops the generic electrical junction box for a photovoltaic module in such a way as to make the connection cables especially easy and cost-effective to align.

In an embodiment of the invention, the box lid can be placed on the box receptacle in two or more different fitting positions. A positive contact and a negative contact in the box receptacle are provided for each fitting position. According to an embodiment of the invention, the contacts in the box receptacle and mating contacts in the box lid are situated in such a way that, in each fitting position of the box lid on the box receptacle, the positive mating contact in the box lid can be electrically contacted with one of the positive contacts in the box receptacle, and the negative mating contact in the box lid can be electrically contacted with one of the negative contacts in the box lid. The final fitting position of the box lid on the box receptacle is then selected according to an embodiment of the invention based on a prescribed alignment of the connection cables relative to the photovoltaic module. Therefore, an embodiment of the invention makes it possible to align the connection cable relative to the photovoltaic module depending on how much space is specifically available. In addition, it can be geared toward having the shortest possible connection cable to the object being connected, for example. The box receptacle can be preassembled on the laminate completely independently of the photovoltaic module to be produced. The connection cables are then aligned on the finished photovoltaic module by correspondingly fitting the box lid with the connection cables rigidly mounted thereto. In this case, the same box lid can be put on for each fitting position, and the same box lid can also be used for any photovoltaic module desired, provided the matching box receptacle is always preassembled first. This yields an especially easy and inexpensive way to align the connection cables on a photovoltaic module in nearly any way desired via the simple, adjusted fitting of the box lid on the box receptacle of a junction box.

In principle, then, the electrical junction box according to an embodiment of the invention provides a pair of opposite-polarity mating contacts in the box lid, and n pairs of opposite-polarity contacts corresponding to a number n of possible fitting positions for the box lid on the box receptacle. This definition will continue to be used in the same way below. However, this does not rule out that each mating contact can consist of a number m of individual contacts. In this case, each contact will correspondingly also exhibit m individual contacts. As a consequence, the box receptacle incorporates m n individual contacts, while only m individual contacts are arranged in the box lid. However, since all individual contacts are electrically interconnected, they end up corresponding to a single contact or mating contact.

When placing the box lid on the box receptacle, the contacts in the box receptacle are contacted with the mating contacts in the box lid in such a way that the positive pole of the photovoltaic module formed by the positively charged cross connection link in the photovoltaic module is connected in an electrically conductive manner with the positive connection cable, and the negative pole formed in the negatively changed cross connection link in the photovoltaic module is connected in an electrically conductive manner with the negative connection cable. To ensure that a reliable contact is established, the contacts in the box receptacle can be designed as clamping contacts, into which the mating contacts configured as blade contacts in the box lid engage and contact when the box lid is placed on the box receptacle. A precondition for this type of contacting is that the box lid be perpendicularly fitted onto the box receptacle. As an alternative, the contacts or mating contacts can advantageously also be resiliently mounted in the box receptacle or box lid. This yields a sufficient contacting force. In addition, the mating contacts can be slipped onto the contacts from the side. The box lid then no longer needs to be precisely fitted vertically onto the box receptacle. The box lid can be placed onto the box receptacle in an approximate fitting position, and then aligned laterally for contacting purposes.

In the fitting position, it is preferred and advantageous that the box lid be either positively or non-positively rigidly connected with the box receptacle in a fitting position in order to seal the junction box against moisture and electrically safeguard the junction box. A positive fit can be achieved with the corresponding locking clamps, in which elastically deformable hooks on the box lid engage into elastically deformable hooks on the box receptacle. A non-positive fit between the box lid and box receptacle can be achieved through friction, for example by having the box lid overlap the box receptacle like a clamp. The box lid and box receptacle can also be (detachably) adhesively bonded or bolted to generate a non-positive fit.

According to an embodiment of the invention, the box lid can be placed onto the box receptacle in various fitting positions, wherein the contact between the contacts in the box receptacle and mating contacts in the box lid is reliably established in each fitting position. To this end, the box receptacle provides as many pairs of positive and negative contacts as there are fitting positions. The box lid incorporates at least one pair of positive and negative mating contacts, which then contact the corresponding pair of contacts in the selected fitting position. Reliable contacting requires that the different fitting positions be precisely defined. The various fitting positions are preferably and advantageously set using dowel pins, or via a geometric fit between the box lid and box receptacle. During the application of dowel pins, pairs of two dowel pins with complementary shapes arranged at the corresponding position in the box lid and box receptacle are used, based on the number of different fitting positions. In this case, exactly one dowel pin in the box lid fits only in exactly one dowel pin in the box receptacle for each fitting position.

As an alternative, the various fitting positions can also be defined by a geometric fit between the box lid and box receptacle. The geometric fit can here preferably be generated between a continuous wall of the box receptacle and a continuous wall of the box lid. In this case, the inside of the wall of the box lid can encompass the outside of the wall of the box receptacle. This configuration is analogous to a box. Alternatively, the two walls can also abut each other at the front, and exhibit mutually complementary shoulders or grooves and springs. The geometric fit is then generated by the shoulders or grooves and springs, wherein the box lid and box receptacle also preferably exhibit an identical geometric shape.

The geometric fit of a box is advantageously realized particularly well if the box receptacle and box lid preferably exhibit a regular geometric fit with n>2 corners for n different fitting positions each turned by 360°/n degrees. This results in regular n-corners, starting with a triangle, wherein this shape is more rarely realized for a junction box, and on to squares, pentagons, hexagons, octagons, and so on. The number n of corners determines the number of different fitting positions. Accordingly, a pair consisting of one positive and one negative contact is provided in the box receptacle for each fitting position, meaning that a total of n positive and n negative contacts are located in the box receptacle. The corresponding pairs of contacts can here be arranged one directly next to each other or in whatever way desired relative to each other. Their relative configuration is determined by the arrangement of the two matching contacts in the box lid, which contact a pair of contacts in the box receptacle in each fitting position.

One preferred embodiment provides that the regular geometric fit for the box receptacle and box lid be configured with n=4 of a square for 4 different fitting positions each turned by 90°. Each corner of the box receptacle advantageously designed as a square can here exhibit a pair consisting of one positive and one negative contact, and one corner of the box lid shaped like a square can exhibit a pair consisting of one positive and one negative mating contact. This yields a very simple and straightforward allocation of contacts and mating contacts in the four corners of the square. The two connection cables are rigidly connected with the mating contacts in the box lid. As a rule, the connection cables extend in the box plane, i.e., they depart laterally from the box lid. While they can also extend perpendicularly from the box lid, this only produces a limited change in position for the connection cables between the individual fitting positions. However, such a configuration can be used when the junction box is laterally assembled on the frame of a photovoltaic module, meaning perpendicularly to the module plane. Given a lateral arrangement of the connection cables from the junction box, a square configuration of the latter thus allows the two connection cables to depart from the junction box in four different directions. In this case, the positive and negative connection cable can advantageously depart from the box lid shaped like a square, from the wall lying opposite the corner with a pair consisting of one positive and one negative mating contact. This makes it easy to handle the box lid during its placement.

Another advantageous embodiment provides that the box receptacle and box lid in the regular geometric shape be designed like an octagon with n=8 for 8 different fitting positions each turned by 45°. The box receptacle designed like an octagon can here exhibit a pair consisting of one positive and one negative contact in front of each edge, and the box lid designed like an octagon can exhibit a pair consisting of one positive and one negative mating contact in front of an edge. The positive and negative connection cable can preferably depart from the box lid designed like an octagon, from the wall lying opposite the edge with the pair consisting of the positive and negative mating contact. By comparison to the embodiment mentioned above, this embodiment with an octagonal junction box yields eight different fitting positions, and hence eight different possible alignments for the two connection cables. With this embodiment, the junction box can be adjusted to nearly any situation with regard to space on a photovoltaic module, and the connection cables can be optimally aligned.

In the configurations with a geometric fit, the number of fitting positions, and hence orientations of the connection cables, corresponds to the number n of corners. As the number of corners grows, so too does the number of possible alignments. The connection cables can preferably be aligned as desired, i.e., continuously, in cases where the box receptacle and box lid are designed in a regular geometric shape with n=∝ of a circle for an infinite number of fitting positions. Accordingly, the positive contact and negative contact are then designed as concentric annular contact decks. When realizing as high a number of fitting positions as desired, the connection cables can be aligned in whatever orientation wanted. In the round embodiment, however, the selected fitting position between the box lid and box receptacle is no longer automatically fixed as in the angular fit. As a result, the chosen fitting position must be fixed accordingly in the round embodiment, for example, via screw joints. However, the fitting position can alternatively be achieved while establishing the rigid connection already mentioned above between the box lid and box receptacle.

In a round configuration of the junction box with whatever fitting position desired, the contacts in the box receptacle are designed as closed annular contact decks. To enable the latter to run without crossing, and hence short-circuiting, the annular contact decks are arranged concentrically inside each other. The configurations with n different fitting positions can advantageously also exhibit non-intersecting conductor strips, wherein all positive contacts of a strip conductor connected with the negative pole are acquired. A serial connection of contacts is here preferably realized. In this instance, the contacts can be designed as clamping contacts, as described above, or simply as contact points on the strip conductors. In the second case, the mating contacts are preferably resilient in design, so as to reliably ensure contacting. The mating contacts can then be laterally aligned on the contact decks without any problem. However, all positive and negative contacts in the junction box can also be connected either in series or parallel with wires. Wires are electrically insulated in sheaths, and can be easily crossed over each other. Since the box receptacle can be prefabricated independently of the photovoltaic module, realizing more complex wiring is also simple.

During exposure to sunlight, a current flows through a solar cell between the positive and negative pole. Too little exposure to sunlight, for example as the result of shading, can lead to polarity reversal, and hence to a reverse current. The latter can damage the solar cell, along with the entire photovoltaic module. Reverse currents are avoided by using bypass diodes, which only permit one forward direction. Each individual solar cell can here be connected in parallel with a bypass diode. However, bypass diodes are more frequently connected between the positive and negative pole of the entire photovoltaic module. For example, the positive pole of a photovoltaic module can consist of a first and second positive cross connection link, and the negative pole can consist of a corresponding first and second negative cross connection link. A positive cross connection link is always opposed by a negative cross connection link, forming a gap between them. The junction box is set in one gap between the positive and negative pole. In order to prevent a reverse current through the photovoltaic module, the bypass diodes in an electrical circuit are set in the other gap, each between the equal-polarity cross connection links. The bypass diodes in the box receptacle can basically be situated between the cross connection links. However, the bypass diodes can preferably also be provided in the box lid. But to ensure that the bypass diodes are arranged in the same electrical circuit between the cross connection links in each fitting position of the box lid on the box receptacle, it is especially advantageous for the bypass diodes to be located on a twistable or repluggable board. By correspondingly turning back or replugging the board, this makes it possible to counter a twisting by the box lid into another fitting position relative to a basic position. For example, the board can again be fixed by way of dowel pins or via a simple screw joint. Furthermore, additional components can advantageously be provided in the box lid, which need not be integrated into a special electrical circuit. These can be cooling or filtering elements, for example. Further details about the electrical junction box according to the invention may be gleaned from the exemplary embodiments.

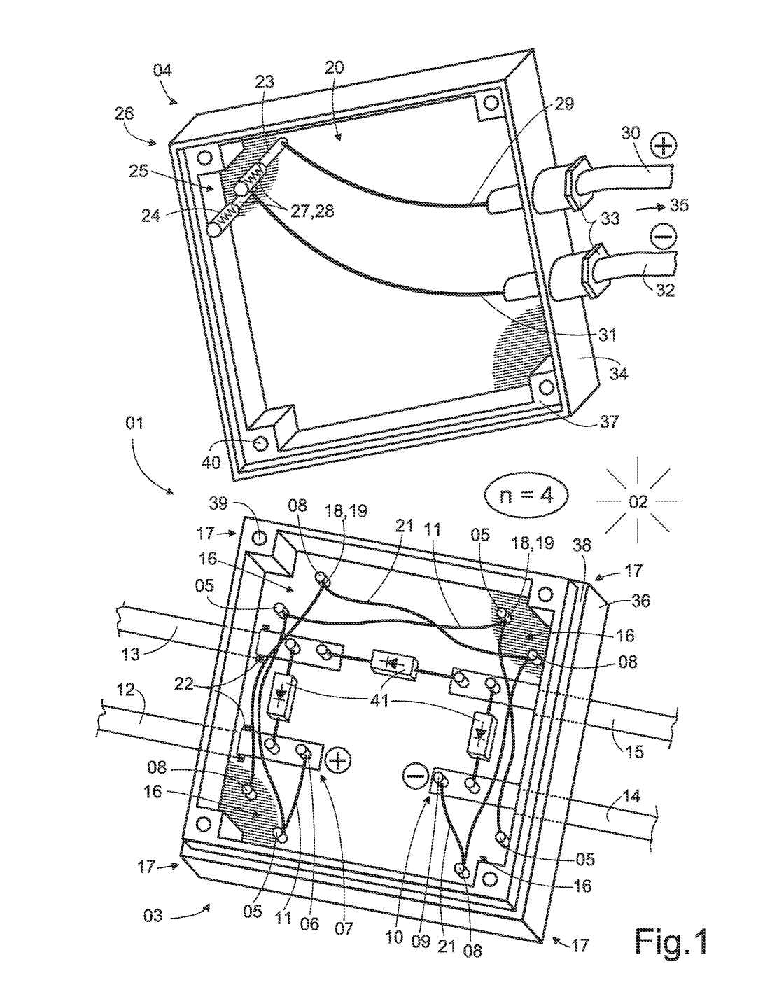

FIG. 1 presents a perspective, open view of an electrical junction box 01 for a photovoltaic module (02) with a box receptacle 03 and a box lid 04. Presented here is a view into the box receptacle 03 from above, and a view into the box lid 04 from below. An embodiment of the invention is depicted with n=4 different fitting positions, having a box lid 04 and box receptacle 03 shaped like a square 20. Accordingly, the box receptacle 03 incorporates four positive contacts 05 with a contacting means 06 for the positive pole 07, and four negative contacts 08 with a contacting means 09 for the negative pole 10 of the photovoltaic module 02. The four positive contacts 05 are interconnected in series in an electrically conductive manner and connected with the contacting means 09 by way of electrically insulating, sheathed wires 11. The four negative contacts 08 are also interconnected in series in an electrically conductive manner and connected with the contacting means 09 by way of electrically insulating, sheathed wires 21. The electrically insulating sheathing makes it possible to cross the wires 11 and 21 without any problem. The junction box 01 is presented in a state wired with the photovoltaic module 02. As a result, a first positive cross connection link 12 and a second positive cross connection link 13 of the photovoltaic module 02 are connected in an electrically conductive manner with the positive pole 07 of the photovoltaic module 02. A first negative cross connection link 14 and a second negative cross connection link 15 are connected in an electrically conductive manner with the negative pole 10 of the photovoltaic module 02. To this end, the cross connection links 12, 13, 14, 15 are routed into the interior of the box receptacle 03 via slits 22 incorporated in the latter. The cross connection links 12, 13, 14, 15 are electrically integrated into a series connection of solar cells in the photovoltaic module 02. In order to prevent a reverse current, bypass diodes 41 with the specified conducting direction are connected between the cross connection links 12, 13, 14, 15.

In the exemplary embodiment shown, four pairs 16 are each comprised of a positive contact 05 and a negative contact 08, and arranged in corners 17 of the box receptacle 03. The contacts 05, 07 in the box receptacle 03 are designed as pin contacts 18, and their faces exhibit troughs 19.

Depicted in the box lid 04 are a positive mating contact 23 and a negative mating contact 24. The two mating contacts 23, 24 are combined to form a pair 25, similarly to the pairs 16 consisting of contacts 05, 08, and positioned in a corner 26 of the box lid 04. The mating contacts 23, 24 are designed as resilient pin contacts 27, the face of which exhibits a curvature 28. With the box lid 04 donned, the elastic force of the resilient pin contacts 27 presses these curvatures 28 into the troughs 19 of the contacts 05, 08 in the box receptacle 02, thereby establishing a reliable contact. The positive mating contact 23 is connected with a positive connection cable 30 via an electrically insulating wire 29. The negative mating contact 24 is connected with a negative connection cable 32 via an electrically insulating wire 31. The two connection cables 30, 32 are rigidly connected by strain reliefs 33 in a continuous wall 34 of the box lid 04, and exhibit a fixed laterally outgoing direction 35 (arrow).

The box receptacle 03 also exhibits a continuous wall 36. The continuous wall 34 of the box lid exhibits a frontal shoulder 37, and the continuous wall 36 of the box receptacle 03 exhibits a frontal shoulder 38 complementary thereto. When placed onto each other, the shoulders 37, 38 engage into each other, and fixedly secure the box lid 04 on the box receptacle 03. A gasket can here be interspersed. The box lid 04 and box receptacle 03 can subsequently be fixedly secured to each other by means of a screw joint, which engages into boreholes 39.40.

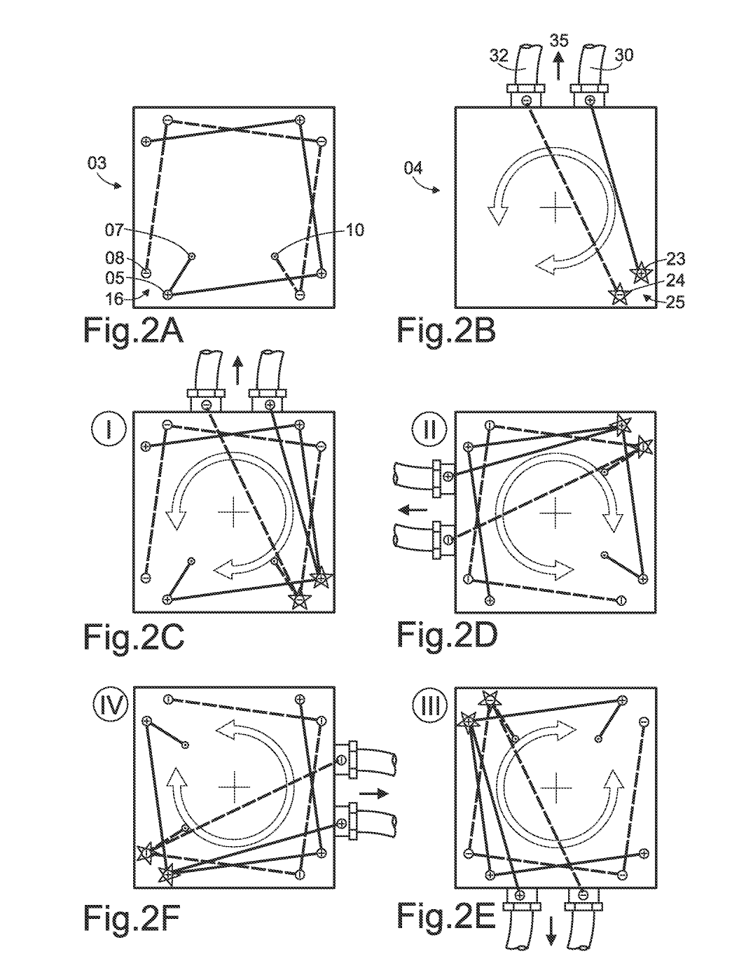

The four different fitting positions for the square junction box 01 outlined above will now be described below. FIG. 2A shows the box receptacle 03 with four pairs 16 of contacts 05, 08. The positive contacts 05 are connected with the positive pole 07, while the negative contacts 08 are connected with the negative pole 10. All respective contacts 05, 08 are connected in series.

FIG. 2B shows the box lid 04 with the pair 25 of mating contacts 23, 24, and the connection cables 30, 32 with the outgoing direction 35. The dashed double arrow denotes that the box lid 04 can be turned clockwise and counterclockwise.

FIG. 2C shows a first fitting position I with an upward outgoing direction 35. The pair 25 of mating contacts 23, 24 contacts the pair 16 of contacts 05, 08 on the bottom right. FIG. 2D shows a second fitting position II with a leftward outgoing direction 35. By comparison to fitting position I, fitting position II is achieved by turning the box lid 04 counterclockwise by 90°. The pair 25 of mating contacts 23, 24 contacts the pair 16 of contacts 05, 08 on the top right. FIG. 2E depicts a third fitting position III with a downward outgoing direction 35. By comparison to fitting position I, fitting position III is achieved by turning the box lid 04 clockwise or counterclockwise by 180°. The pair 25 of mating contacts 23, 24 contacts the pair 16 of contacts 05, 08 on the top left. FIG. 2F shows a fourth fitting position VI with a rightward outgoing direction 35. By comparison to fitting position I, fitting position VI is achieved by turning the box lid 04 clockwise by 90°. The pair 25 of mating contacts 23, 24 contacts the pair 16 of contacts 05, 08 on the bottom right.

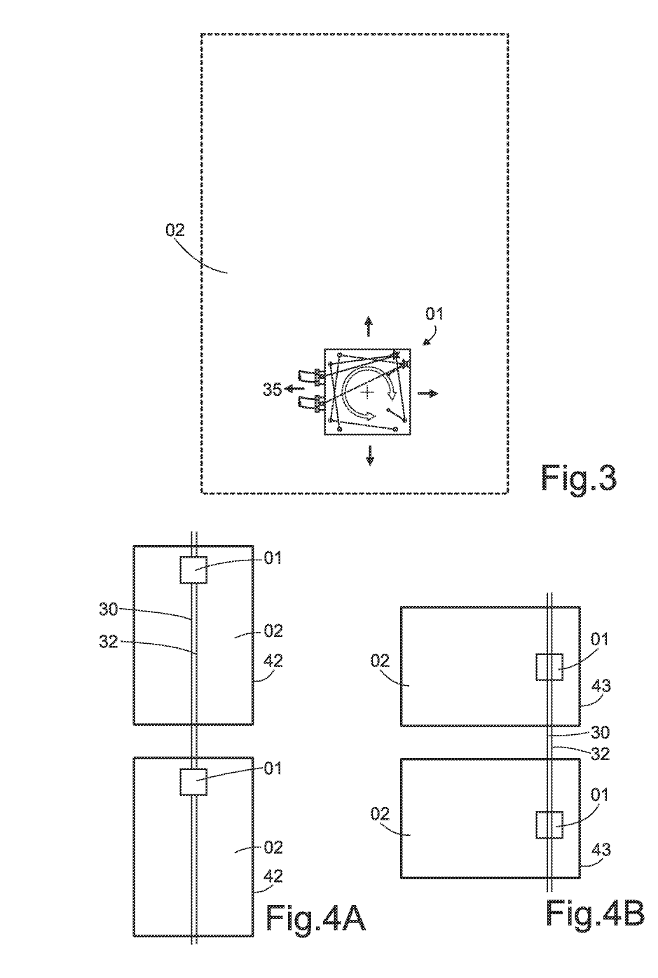

FIG. 3 shows how the junction box 01 is arranged on the photovoltaic module 02, and depicts the four possible outgoing directions 35 of the outgoing lines 30, 32 in relation to the photovoltaic module 02. FIG. 4A shows a series connection of two photovoltaic modules 02 over their long longitudinal side 42, while FIG. 4B shows a series connection of two photovoltaic modules 02 over their short transverse side 43. As evident, the connection cables 30, 32 on FIG. 4B are distinctly shorter than on FIG. 4A.

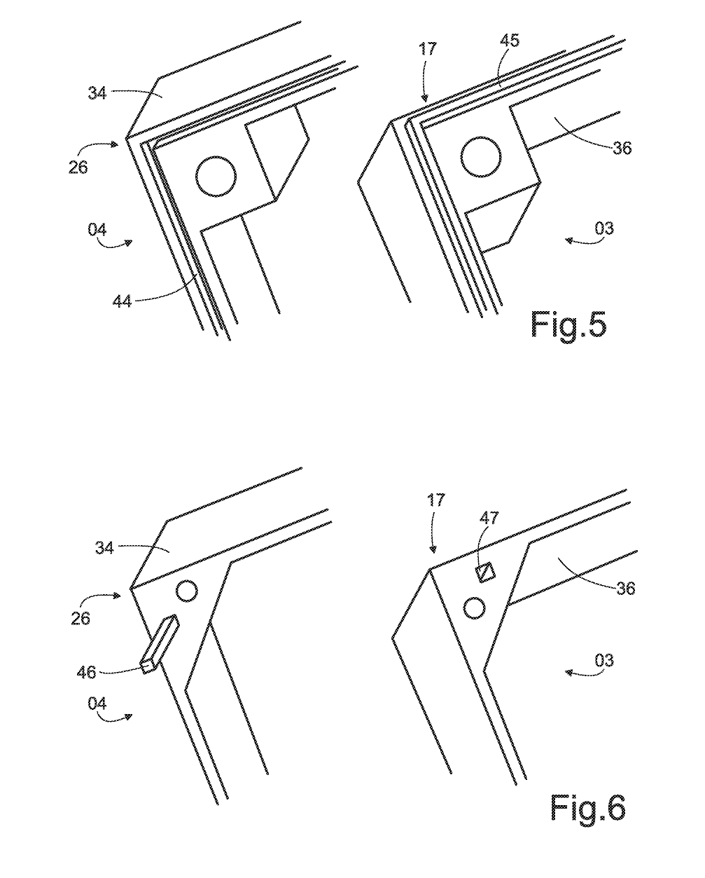

FIG. 5 presents a detailed view of the corner 26 of the box lid 04 in the wall 34 or the corner 17 of the box receptacle 03 in the wall 36. However, in this embodiment, the walls 34, 36 exhibit a groove 44 and a spring 45 to secure the different fitting positions, but these also require that the walls 34, 36 of the box lid 04 and box receptacle 03 fit precisely relative to each other. On FIG. 6, the faces of the walls 34, 35 come to bluntly abut each other, and thus cannot be used to establish the various fitting positions. To establish the latter, the box lid 04 exhibits at least two dowel pins 46 (at opposite corners 26), which can be fitted into the corresponding dowel holes 47 at all four corners 17 on the box receptacle 03.

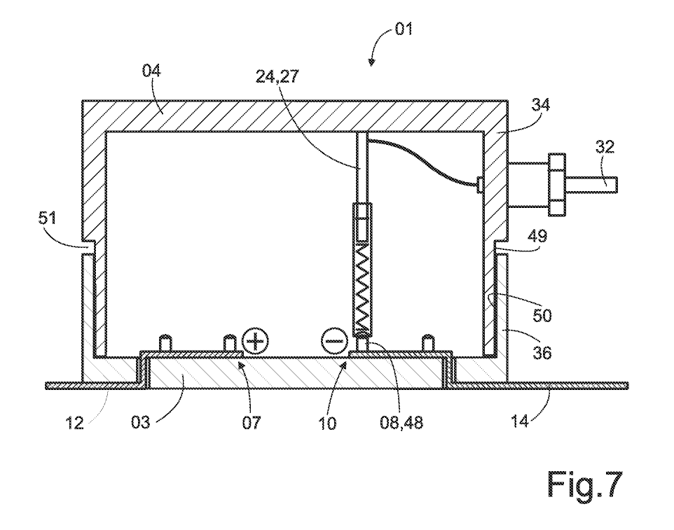

FIG. 7 presents a diagrammatic cross section through the junction box 01. In evidence are the box lid 04, the box receptacle 03, the negative connection line 32 and the cross connection links 14 (connected with the negative pole 10) and 12 (connected with the positive pole 07). In the exemplary embodiment depicted, the negative mating contact 24 is again designed as a resilient contact pin 27. However, the contact 08 is now configured as a simple contact point 48, on which the resilient contact pin 27 simply rests. A lateral alignment is possible. Also evident is that an outside 49 of the wall 34 of the box lid 04 touches an inside 50 of the wall 36 of the box receptacle 03, allowing it to become securely fitted. A gap 51 is also provided for inserting a gasket.

FIG. 8 shows an exemplary embodiment of the junction box 01 with n=8 corners, thereby creating an octagon 52. Depicted on the left is the octagonal box receptacle 03 with eight pairs 16 of contacts 05, 08, which are arranged orthogonally relative to the edges 53. A parallel configuration is also easily possible. The contacts 05, 08 are designed as contact points 48, and lie on non-intersecting strip conductors 54, 55. Bypass diodes 41 are again provided between the cross connection links 12, 13, 14, 15. Shown on the right is the octagonal box lid 04, in which the pair 25 of mating contacts 23, 24 are also situated orthogonally in front of an edge 64. This results in eight different ways of fitting the box lid 04 onto the box receptacle 03, each involving an incremental turn by a respective 45°, and thus eight different outgoing directions 35 for the connection cables 30, 32.

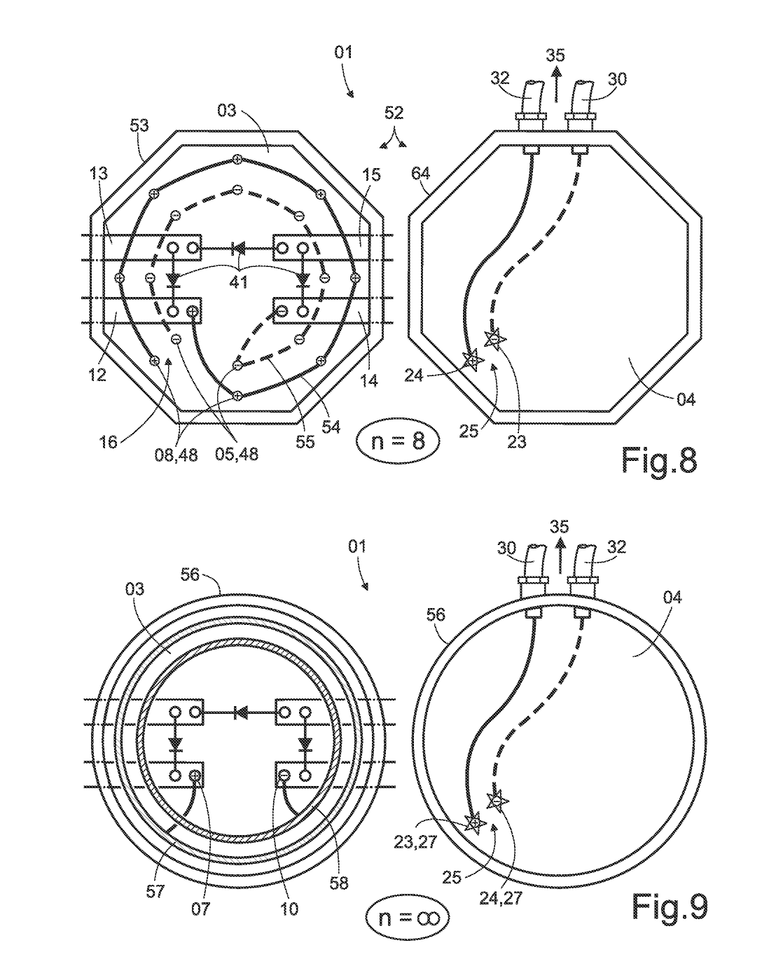

FIG. 9 shows a junction box 01 shaped like a circle 56 (with n=∝). Depicted in the round box receptacle 03 are two concentric annular contact decks 57, 58, which are connected with the positive pole 07 or negative pole 10 of the photovoltaic module 02. The round box lid 04 is configured as illustrated on FIG. 8, and again exhibits a pair 25 of mating contacts 23, 24, which are designed as resilient contact pins 27. The box lid 04 can be placed onto the box receptacle 03 in any fitting position desired, with as many outgoing directions 35 as desired resulting for the connection cables 30, 32 in the circle 56. The selected fitting position can be securely fixed by means of dowel pins (as shown above, or using other positive or non-positive measures, separately from the process of locking the box lid 04 onto the box receptacle 03 or in conjunction therewith.

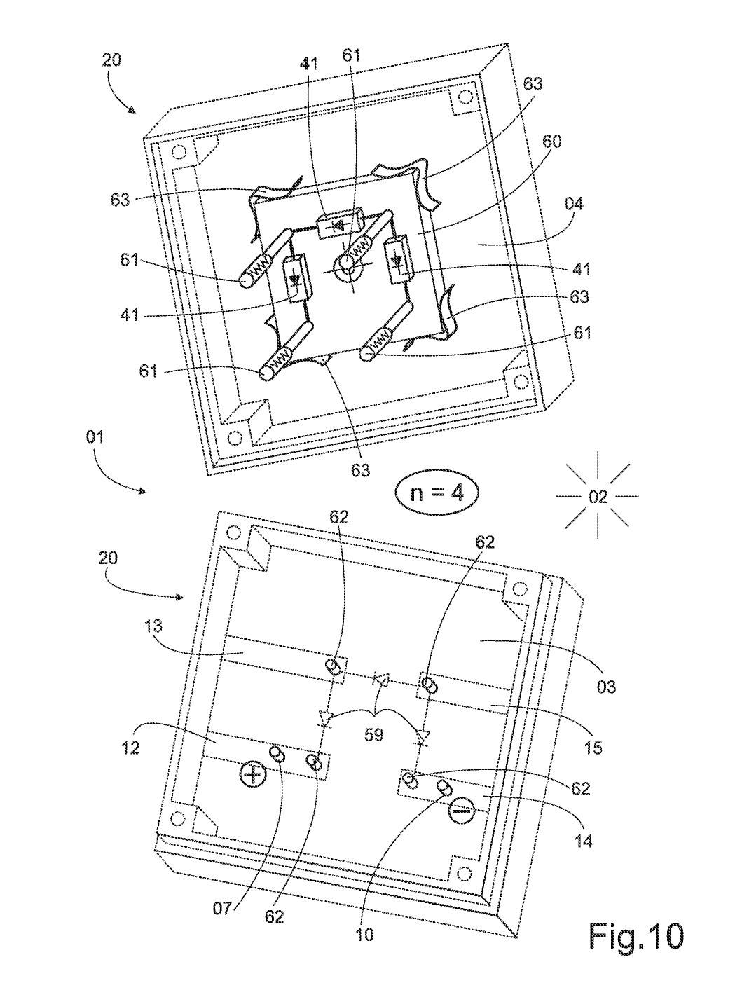

In the preceding exemplary embodiments, the bypass diodes 41 are arranged in the box receptacle 03. FIG. 10 shows a possible configuration of the bypass diodes 41 in the box lid 04. The bypass diodes 41 must always connect the cross connection links 12, 13, 14, 15 in an identical electrical circuit 59 in the photovoltaic module 02 via their linkage with the positive pole 07 and negative pole (denoted with dashed lines, see bypass diodes 41 for forward and reversed directions), so as to reliably prevent a damaging reverse current through the photovoltaic module 02. This also holds true when arranging the bypass diodes 41 in the box lid 04, which can be situated in various fitting positions relative to the box receptacle 03. On FIG. 10, the bypass diodes 41 are arranged on a board 60, and wired by way of resilient plug-in contacts, which can be electrically contacted with mating plug-in contacts 62 in the box receptacle 03 (for example, similarly to how the contacts 05, 08 are contacted with the mating contacts 23, 24 according to FIG. 1). The mating plug-in contacts 62 are correspondingly connected with the conductor strips 12, 13, 14, 15. In the exemplary embodiment shown, the board 60 is mounted so that it can rotate in the box lid 04, and is fixed in place by chuck springs 63 connected with the box lid 04. The board 60 exhibits a geometric shape identical to the box lid 04, specifically the square 20 (n=4) in the exemplary embodiment shown, so as to be able to offset the fitting positions caused by the geometric fit. In order to reach the selected fitting position in the original position for purposes of realizing the prescribed circuit 59, the board 60 must be manually turned or replugged in the example depicted. The chuck springs 63 permit a rotation via the corners of the board 60, and then fix the latter in place again at other corners after twisting is complete. The board 60 must be turned or replugged to such an extent that the prescribed circuit 59 is again correctly reestablished between the conductor strips 12, 13, 14, 15 for a desired fitting position of the box lid 04 on the box receptacle 03. When the box lid 04 is placed on the box receptacle 03, the spring contacts 61 contact the mating contacts 62.

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

### LIST OF REFERENCE NUMERALS

01 Electrical junction box
02 Photovoltaic module
03 Box receptacle
04 Box lid
05 Positive contact
06 Contacting means of 07
07 Positive pole
08 Negative contact
09 Contacting means of 10
10 Negative pole
11 Wire
12 First positive cross connection link
13 Second positive cross connection link
14 First negative cross connection link
15 Second negative cross connection link
16 Pair
17 Corner of 03
18 Pin contact
19 Trough
20 Square
21 Wire
22 Slit
23 Positive mating contact
24 Negative mating contact
25 Pair
26 Corner of 04
27 Pin contact
28 Curvature
29 Wire
30 Positive connection cable
31 Wire
32 Negative connection cable
33 Strain relief
34 Wall of 04
35 Outgoing direction of 30, 31
36 Wall of 03
37 Shoulder
38 Shoulder
39 Borehole
40 Borehole
41 Bypass diode
42 Long longitudinal side of 02
43 Short transverse side of 02
44 Groove
45 Spring
46 Dowel pin
47 Dowel hole
48 Contact point
49 Outside 49 of 34
50 Inside of 36
51 Gap
52 Octagon
53 Edge of 03
54 Strip conductor
55 Strip conductor
56 Circle
57 Positive annular contact deck
58 Negative annular contact deck
59 Electrical circuit
60 Board
61 Spring contact
62 Mating contact for 61
63 Chuck spring
64 Edge of 04

1. An electrical junction box for a photovoltaic module comprising:
a box receptacle including a plurality of positive contacts configured to contact a positive pole of the photovoltaic module and a plurality of negative contacts configured to contact a negative pole of the photovoltaic module; and
a box lid including a positive connection cable connected to at least one positive mating contact and a negative connection cable connected to at least one negative mating contact, the connection cables being connected to the box lid in a fixed outgoing direction, the box lid being configured to be disposed on the box receptacle in a plurality of selectable fitting positions each based on a respective predetermined alignment of the connection cables, a respective one of the positive contacts and a respective one of the negative contacts of the box receptacle being associated with each fitting position,
wherein, in each fitting position, the at least one positive mating contact and the at least one negative mating contact of the box lid are configured to respectively electrically contact the associated respective positive contact and the associated respective negative contact of the box receptacle.

2. The electrical junction box according to claim 1, wherein at least one of the contacts of the box receptacle and the mating contacts of the box lid are configured as resilient pin contacts.

3. The electrical junction box according to claim 1, wherein the box lid is configured to be positively or non-positively connected with the box receptacle in each of the fitting positions.

4. The electrical junction box according to claim 1, wherein the box lid is disposed in each of the fitting positions using at least one of dowel pins and a geometric fit between the box lid and box receptacle.

5. The electrical junction box according to claim 4, wherein the geometric fit is provided between a continuous wall of the box receptacle and a continuous wall of the box lid, wherein the inside or outside of the wall of the box lid touches an outside or inside of the wall of the box receptacle, or both walls abut each other at a front, and include mutually complementary shoulders or springs and grooves.

6. The electrical junction box according to claim 4, wherein the box receptacle and box lid have a regular geometric fit with respect to each other with n>2 corners for n different fitting positions, each of the corners being turned by 360°/n degrees relative to one another.

7. The electrical junction box according to claim 6, wherein the box receptacle and box lid in the regular geometric fit are each configured as a square with n=4 and four different fitting positions each turned by 90°.

8. The electrical junction box according to claim 7, wherein the box receptacle includes a pair of contacts including one of the positive contacts and one of the negative contacts at each corner of the square, and wherein the box lid includes a pair of mating contacts including the at least one positive mating contact and the at least one negative mating contact at only one corner of the square.

9. The electrical junction box according to claim 8, wherein the positive connection cable and the negative connection cable extend from the box lid from a wall of the box lid that is opposite to the corner of the box lid having the pair of mating contacts.

10. The electrical junction box according to claim 6, wherein the box receptacle and box lid in the regular geometric fit are each configured as an octagon with n=8 and eight different fitting positions each turned by 45°.

11. The electrical junction box according to claim 10, wherein the box receptacle includes a pair of contacts including one of the positive contacts and one of the negative contacts in front of each edge of the octagon, and wherein the box lid includes a pair of mating contacts including the at least one positive mating contact and the at least one negative mating contact in front of only one edge of the octagon.

12. The electrical junction box according to claim 11, wherein the positive connection cable and the negative connection cable extend from the box lid from a wall of the box lid that is opposite to the edge of the box lid having the pair of mating contacts.

13. The electrical junction box according to claim 6, wherein the box receptacle and the box lid in the regular geometric are each configured as a circle with n=∝ and an infinite number of fitting positions with an infinite number of the positive contacts and an infinite number of the negative contacts, the infinite number of positive contacts being configured as a positive annular contact deck and the infinite number of negative contacts being configured as a negative annular contact deck, the positive and the negative annular contact decks being aligned concentrically.

14. The electrical junction box according to claim 1, wherein each of the positive contacts are connected in parallel or series with at least one of intersecting wires and non-intersecting strip conductors and wherein each of the negative contacts are connected in parallel or series with at least one of intersecting wires and non-intersecting strip conductors.

15. The electrical junction box according to claim 1, further comprising bypass diodes disposed on a board in the box lid which is configured to be twisted or replugged in the box lid, based on a respective one of the fitting positions, such that the bypass diodes form an electrical circuit of the positive pole with the negative pole of the photovoltaic module.
